(19) United States
(12) Patent Application Publication
(10) Pub. No.: US 2012/0186454 A1
(43) Pub. Date: Jul. 26, 2012

(54) AERATION APPARATUS, SEAWATER FLUE GAS DESULPHURIZATION APPARATUS INCLUDING THE SAME, AND OPERATION METHOD OF AERATION APPARATUS

(76) Inventors: Keisuke SONODA, Tokyo (JP); Shozo Nagao, Tokyo (JP)

(21) Appl. No.: 13/218,611

(22) Filed: Aug. 26, 2011

Related U.S. Application Data
(60) Provisional application No. 61/441,706, filed on Feb. 11, 2011.

(30) Foreign Application Priority Data
Jan. 21, 2011 (JP) 2011-011413

(51) Int. Cl. C02F 1/74; B01F 3/04; B01D 47/00

(52) U.S. Cl. 96/235; 261/121.1; 210/758

(57) ABSTRACT

An aeration apparatus that is immersed in diluted used seawater (not shown), which is water to be treated, and generates fine air bubbles in the diluted used seawater. This aeration apparatus includes: an air supply line L₅ that supplies air 122 through blowers 121A to 121D (in an embodiment of the preset invention, four blowers) serving as discharge units; a pressure gauge 125 installed in the air supply line L₅; and aeration nozzles 123 each including a diffuser membrane 11 having slits for supplying the air, so that when air supply pressure exceeds a predetermined threshold value based on a result of measurement by the pressure gauge 125, fresh water 141 or water vapor is temporarily supplied to an air supply pipe.

### FIELD

The present invention relates to wastewater treatment in a flue gas desulphurization apparatus used in a power plant such as a coal, crude oil, or heavy oil combustion power plant. In particular, the invention relates to an aeration apparatus for aeration used for decarboxylation (air-exposure) of wastewater (used seawater) from a flue gas desulphurization apparatus for desulphurization using a seawater method. The invention also relates to a seawater flue gas desulphurization apparatus including the aeration apparatus and to an operation method of the aeration apparatus.

### BACKGROUND

In conventional power plants that use coal, crude oil, and the like as fuel, combustion flue gas (hereinafter referred to as “flue gas”) discharged from a boiler is emitted to the air after sulfur oxides (SOₓ) such as sulfur dioxide (SO₂) contained in the flue gas are removed. Known examples of the desulphurization method used in a flue gas desulphurization apparatus for the above desulphurization treatment include a limestone-gypsum method, spray dryer method, and seawater method.

In a flue gas desulphurization apparatus that uses the seawater method (hereinafter referred to as a “seawater flue gas desulphurization apparatus”), its desulphurization method uses seawater as an absorbent. In this method, seawater and flue gas from a boiler are supplied to the inside of a desulfurizer (absorber) having a vertical tubular shape such as a vertical substantially cylindrical shape, and the flue gas is brought into gas-liquid contact with the seawater used as the absorbent in a wet process to remove sulfur oxides. The seawater (used seawater) used as the absorbent for desulphurization in the desulfurizer flows through, for example, a long water passage having an open upper section (Seawater Oxidation Treatment System: SOTS) and is then discharged. In the long water passage, the seawater is decarbonated (exposed to air) by aeration that uses fine air bubbles ejected from an aeration apparatus disposed on the bottom surface of the water passage (Patent documents 1 to 3).

### Citation List

### Patent Literature

Patent Literature 1: Japanese Patent Application Laid-open No. 2006-055779

Patent Literature 2: Japanese Patent Application Laid-open No. 2009-028570

Patent Literature 3: Japanese Patent Application Laid-open No. 2009-028572

### SUMMARY

### Technical Problem

Aeration nozzles used in the aeration apparatus each have a large number of small slits formed in a rubber-made diffuser membrane that covers a base. Such aeration nozzles are generally referred to as “diffuser nozzles”. These aeration nozzles can eject many fine air bubbles of substantially equal size from the slits with the aid of the pressure of the air supplied to the nozzles.

When aeration is continuously performed in seawater using the above aeration nozzles, salt such as calcium sulfate in the seawater is deposited on the wall surfaces of the slits of the diffuser membranes and around the openings of the slits, causing the gaps of the slits to be narrowed and the slits to be clogged. This results an increase in pressure loss of the diffuser membranes, and the discharge pressure of discharge unit, such as a blower or compressor, for supplying the air to the diffuser is thereby increased, so that disadvantageously the load on the blower or compressor increases.

The occurrence of the precipitates may be due to the following reason. Seawater present outside a diffuser membrane permeates inside the diffuser membrane through its slits and comes into continuous contact with air passing through the slits for a long time. Drying (concentration of the seawater) is thereby facilitated, and the precipitates are deposited.

In view of the above problem, it is an object of the present invention to provide an aeration apparatus that can remove precipitates generated in the slits of diffuser membranes, a seawater flue gas desulphurization apparatus including the aeration apparatus, and an operation method of the aeration apparatus.

### Solution to Problem

According to an aspect of the present invention, an aeration apparatus that is immersed in water to be treated and generates fine air bubbles in the water to be treated, includes: an air supply pipe for supplying air through a discharge unit; a pressure gauge installed in the air supply pipe; and an aeration nozzle including a diffuser membrane having a slit, the air being supplied through the slit to the aeration nozzle. When there is an increase in pressure loss with respect to the diffuser membrane, fresh water or water vapor is temporarily supplied to the air supply pipe.

Advantageously, in the aeration apparatus, determination as to whether there is an increase in pressure loss with respect to the diffuser membrane is performed by at least one of a unit that measures pressure of supplied air or an amount of air, and a unit that measures a current value or number of revolutions of the discharge unit.

Advantageously, in the aeration apparatus, the aeration nozzle includes: a diffuser membrane that covers a support body into which air is introduced; and a number of slits provided in the diffuser membrane, and fine air bubbles are caused to flow out from the slits.

Advantageously, in the aeration apparatus, the aeration nozzle includes: a cylindrical base-side support body into which air is introduced; a hollow cylindrical body having a diameter smaller than that of the base-side support body and provided axially via a partition board; an end support body provided at the other end of the hollow cylindrical body and having a substantially same diameter as that of the base-side support body; a tube-type diffuser membrane that is fastened at opposite ends, while covering the base-side support body and the end support body; a plurality of slits provided in the diffuser membrane; and an air outlet that is provided on a side of the base-side support body and causes air to introduce into a pressurized space between an inner circumference of a diffuser membrane and an outer circumference of a support body to flow out in front of the partition board.

Advantageously, in the aeration apparatus, the aeration nozzle includes: a cylindrical base-side support body into which air is introduced; an end support body having a substantially same diameter as that of the base-side support body; a tube-type diffuser membrane that is fastened while covering the base-side support body and the end support body; and a plurality of slits provided in the diffuser membrane.

According to another aspect of the present invention, a seawater flue gas desulphurization apparatus includes: a desulfurizer that uses seawater as an absorbent; a water passage for allowing used seawater discharged from the desulfurizer to flow therethrough and be discharged; and any one of the aeration apparatus described above that is disposed in the water passage, the aeration apparatus generating fine air bubbles in the used seawater to decarbonate the used seawater.

According to still another aspect of the present invention, an operation method of an aeration apparatus includes: using an aeration apparatus that is immersed in water to be treated and generates fine air bubbles in the water to be treated from a slit; and temporarily supplying fresh water or water vapor when there is an increase in pressure loss with respect to the diffuser membrane, to remove a precipitate in the slit, at a time of supplying air through a discharge unit.

Advantageously, in the operation method of an aeration apparatus, when pressure loss is resolved, fresh water or water vapor is further supplied to prevent clogging of a slit that generates fine air bubbles.

### ADVANTAGEOUS EFFECTS OF INVENTION

According to the present invention, when precipitates are generated in the slits of the diffuser membranes of the aeration apparatus, precipitates can be removed by quickly dealing with this problem, and pressure loss in the diffuser membranes can be reduced, thereby enabling to decrease burdens on a blower, a compressor and the like.

### BRIEF DESCRIPTION OF DRAWINGS

FIG. 1 is a schematic diagram of a seawater flue gas desulphurization apparatus according to a first embodiment.

FIG. 2A is a plan view of aeration nozzles.

FIG. 2B is a front view of the aeration nozzles.

FIG. 3A is a schematic diagram of the inner structure of an aeration nozzle.

FIG. 3B is a schematic diagram of the inner structure of an expanded state of the aeration nozzle.

FIG. 4A is a schematic diagram of an aeration apparatus according to the first embodiment.

FIG. 4B is a schematic diagram of another aeration apparatus according to the first embodiment.

FIG. 5A is a schematic diagram of another aeration apparatus according to the first embodiment.

FIG. 5B is a schematic diagram of another aeration apparatus according to the first embodiment.

FIG. 6A is a schematic diagram of another aeration apparatus according to the first embodiment.

FIG. 6B is a schematic diagram of another aeration apparatus according to the first embodiment.

FIG. 7 is a schematic diagram of the inner structure of another aeration nozzle according to the first embodiment.

FIG. 8 is a schematic diagram of the inner structure of another aeration nozzle according to the first embodiment.

FIG. 9 is a schematic diagram of a disk-type aeration nozzle according to the first embodiment.

FIG. 10A depicts the outflow of air (humid air having a low degree of saturation), the inflow of seawater, and a state of concentrated seawater in the slit of a diffuser membrane.

FIG. 10B depicts the outflow of air, the inflow of seawater, and a state of concentrated seawater in the slit of the diffuser membrane.

FIG. 10C depicts the outflow of air, the inflow of seawater, and states of concentrated seawater and precipitates in the slit of the diffuser membrane.

### DESCRIPTION OF EMBODIMENTS

Hereinafter, the present invention will be described in detail with reference to the drawings. However, the present invention is not limited to embodiments described below. The components in the following embodiments include those readily apparent to persons skilled in the art and those substantially similar thereto.

### Embodiments

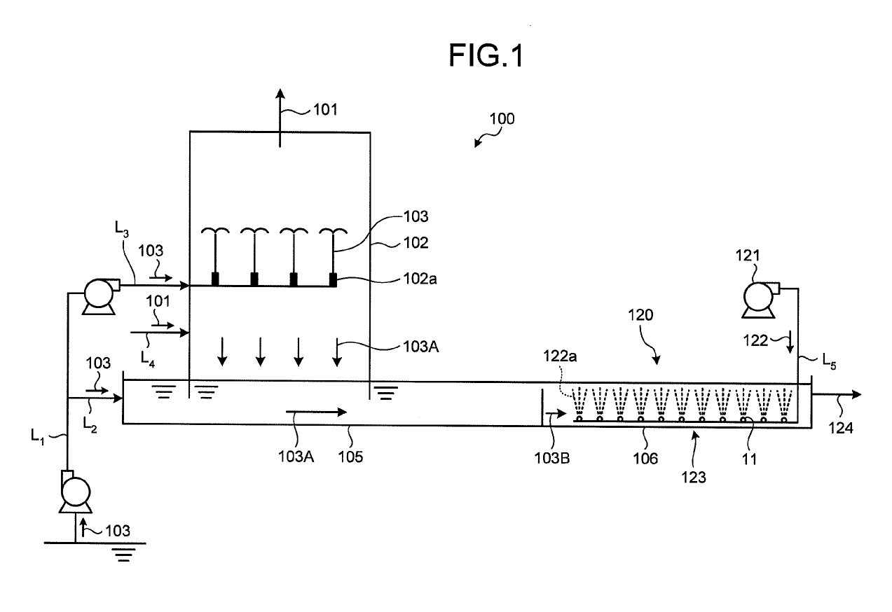

An aeration apparatus and a seawater flue gas desulphurization apparatus according to embodiments of the present invention will be described with reference to the drawings. FIG. 1 is a schematic diagram of the seawater flue gas desulphurization apparatus according to one embodiment.

As shown in FIG. 1, a seawater flue gas desulphurization apparatus 100 includes: a flue gas desulphurization absorber 102 in which flue gas 101 and seawater 103 comes in gas-liquid contact to desulphurize SO₂ into sulfurous acid (H₂SO₃); a dilution-mixing basin 105 disposed below the flue gas desulphurization absorber 102 to dilute and mix used seawater 103A containing sulfur compounds with dilution seawater 103; and an oxidation basin 106 disposed on the downstream side of the dilution-mixing basin 105 to subject diluted used seawater 103B to water quality recovery treatment.

In the seawater flue gas desulphurization apparatus 100, the seawater 103 is supplied through a seawater supply line L₁, and part of the seawater 103 is used for absorption, i.e., is brought into gas-liquid contact with the flue gas 101 in the flue gas desulphurization absorber 102 to absorb SO₂ contained in the flue gas 101 into the seawater 103. The used seawater 103A that has absorbed the sulfur components in the flue gas desulphurization absorber 102 is mixed with the dilution seawater 103 supplied to the dilution-mixing basin 105 disposed below the flue gas desulphurization absorber 102. The diluted used seawater 103B diluted and mixed with the dilution seawater 103 is supplied to the oxidation basin 106 disposed on the downstream side of the dilution-mixing basin 105. Air 122 supplied from an oxidation air blower 121 is supplied to the oxidation basin 106 from aeration nozzles 123 to recover the quality of the seawater, and the resultant water is discharged to the sea as treated water 124.

In FIG. 1, reference numeral 102a represents spray nozzles for injecting seawater upward as liquid columns; 120 represents an aeration apparatus; 122a represents air bubbles; L₁ represents a seawater supply line; L₂ represents a dilution seawater supply line; L₃ represents a desulphurization seawater supply line; L₄ represents a flue gas supply line; and L₅ represents an air supply line.

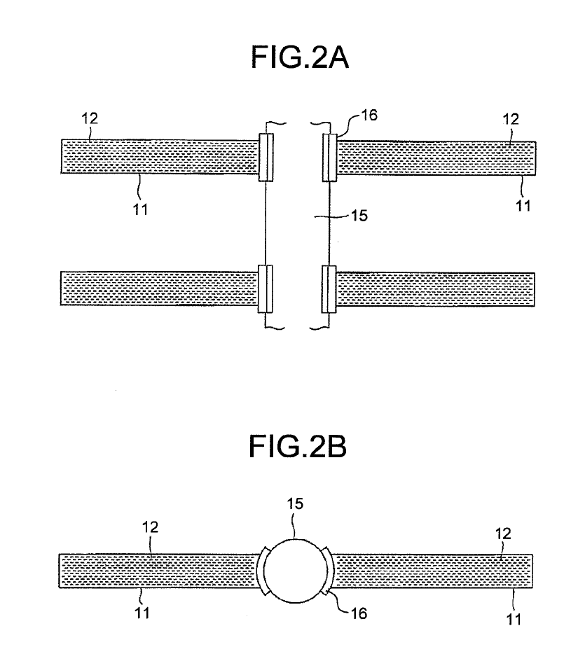

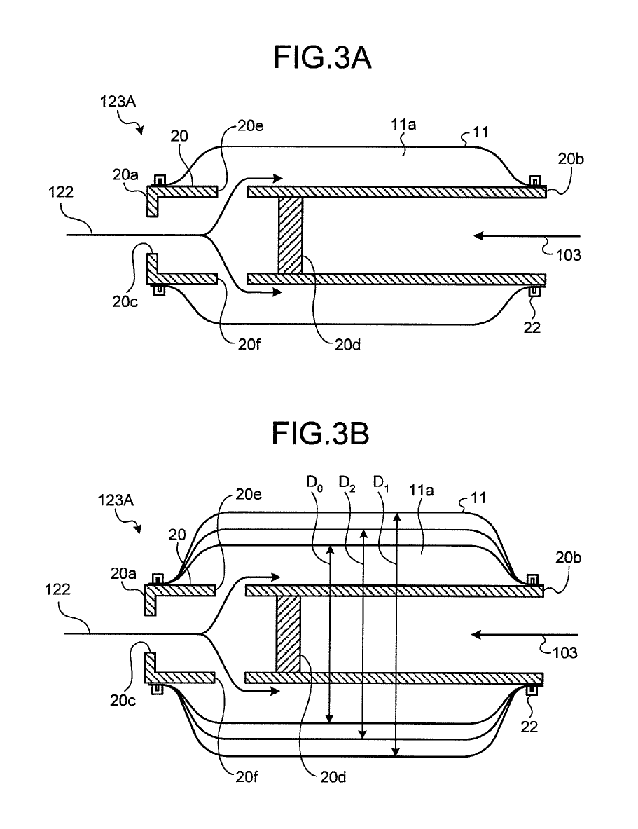

The structure of the aeration nozzles 123 is described with reference to FIGS. 2A, 2B, and 3.

FIG. 2A is a plan view of the aeration nozzles; FIG. 2B is a front view of the aeration nozzles; and FIG. 3A is a schematic diagram of the inner structure of an aeration nozzle.

As shown in FIGS. 2A and 2B, each aeration nozzle 123 has a large number of small slits 12 formed in a diffuser membrane 11 that covers the circumference of a base and is generally referred to as a “diffuser nozzle.” In such an aeration nozzle 123, when the diffuser membrane 11 is expanded by the pressure of the air 122 supplied from the air supply line L₅, the slits 12 open to allow a large number of fine air bubbles of substantially equal size to be ejected. As the diffuser membrane 11, a membrane having flexibility such as rubber is preferable.

As shown in FIGS. 2A and 2B, the aeration nozzles 123 are attached through flanges 16 to headers 15 provided in a plurality of (eight in the present embodiment) branch pipes (not shown) branched from the air supply line L₅. In consideration of corrosion resistance, resin-made pipes, for example, are used as the branch pipes and the headers 15 disposed in the diluted used seawater 103B.

A specific configuration of the aeration nozzle 123 is explained with reference to FIG. 3A. As shown in FIG. 3A, an aeration nozzle 123A according to the present embodiment is formed as follows. A substantially cylindrical support body 20 that is made of a resin in consideration of corrosion resistance to the diluted used seawater 103B is used, and a rubber-made diffuser membrane 11 having a large number of slits 12 formed therein is fitted on the support body 20 so as to cover its outer circumference, and then the left and right ends of the diffuser membrane 11 are fastened with fastening members 22 such as wires or bands.

The slits 12 described above are closed in a normal state in which no pressure is applied thereto. In the seawater flue gas desulphurization apparatus 100, because the air 122 is continuously supplied, the slits 12 are constantly in an open state.

A first end 20a of the support body 20 is attached to a header 15 and allows the introduction of the air 122, and the support body 20 has an opening at its second end 20b that allows the introduction of the seawater 103.

In the support body 20, the side close to the first end 20a is in communication with the inside of the header 15 through an air inlet port 20c that passes through the header 15 and the flange 16. The inside of the support body 20 is partitioned by a partition plate 20d disposed at some axial position in the support body 20, and the flow of air is blocked by the partition plate 20d. Air outlet holes 20e and 20f are formed in the side surface of the support body 20 and disposed on the header 15 side of the partition plate 20d. The air outlet holes 20e and 20f allow the air 122 to flow between the inner circumferential surface of the diffuser membrane 11 and the outer circumferential surface of the support body, i.e., into a pressurization space 11a for pressurizing and expanding the diffuser membrane 11. Therefore, the air 122 flowing from the header 15 into the aeration nozzle 123 flows through the air inlet port 20c into the support body 20 and then flows through the air outlet holes 20e and 20f formed in the side surface into the pressurization space 11a, as shown by arrows in FIG. 3.

The fastening members 22 fasten the diffuser membrane 11 to the support body 20 and prevent the air flowing through the air outlet holes 20e and 20f from leaking from the opposite ends.

In the aeration nozzle 123A configured as above, the air 122 flowing from the header 15 through the air inlet port 20c flows through the air outlet holes 20e and 20f into the pressurization space 11a. Since the slits 12 are closed in the initial state, the air 122 is accumulated in the pressurization space 11a to increase the inner pressure. The increase in the inner pressure of the pressurization space 11a causes the diffuser membrane 11 to expand, and the slits 12 formed in the diffuser membrane 11 are thereby opened, so that fine bubbles of the air 122 are injected into the diluted used seawater 103B. Such fine air bubbles are generated in all the aeration nozzles 123A-123C to which air is supplied through branch pipes L_{5A} to L_{5H} and the headers 15 (see FIGS. 3A, 7 and 8).

The aeration apparatus according to the present embodiment will next be described.

The present invention provides means for quickly removing precipitates when they are generated in the slits 12 formed in the diffuser membrane 11.

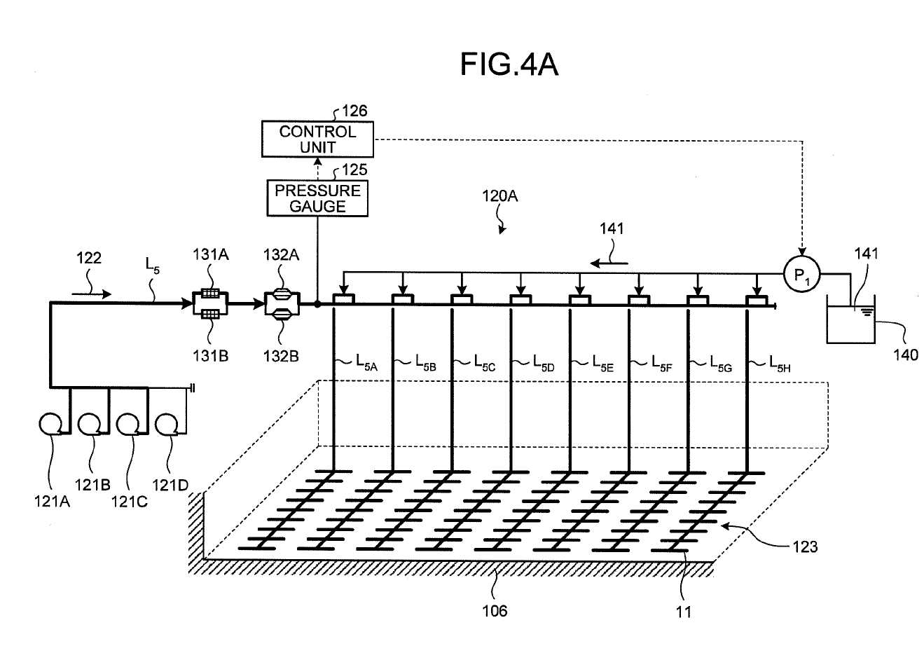

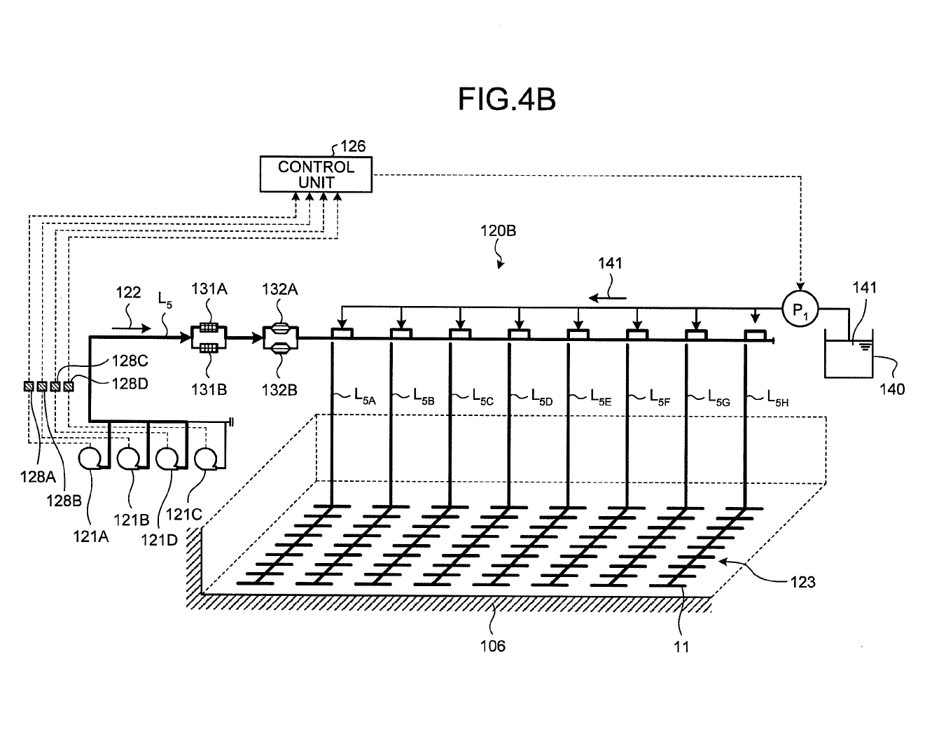

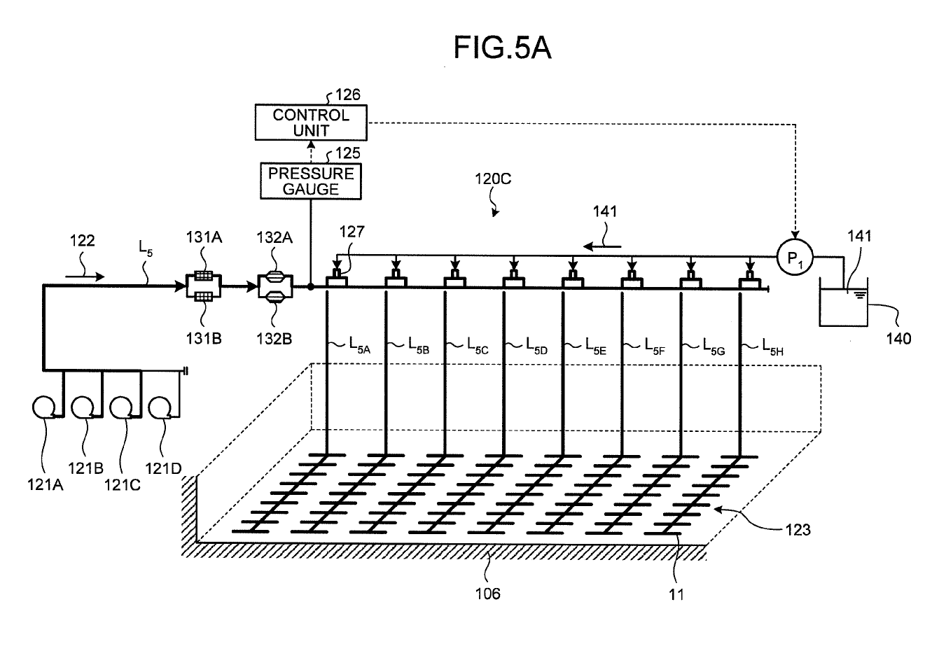

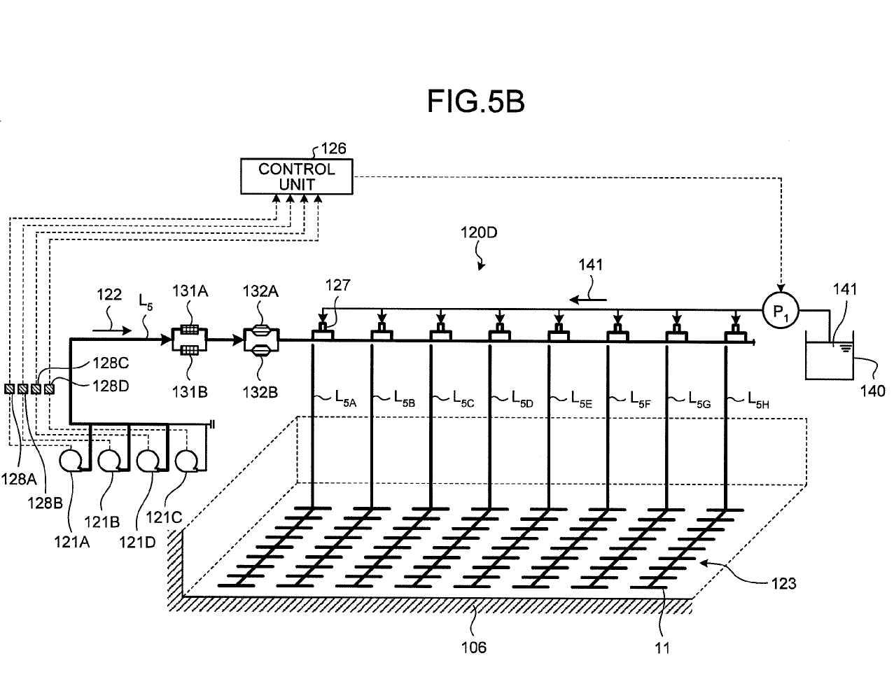

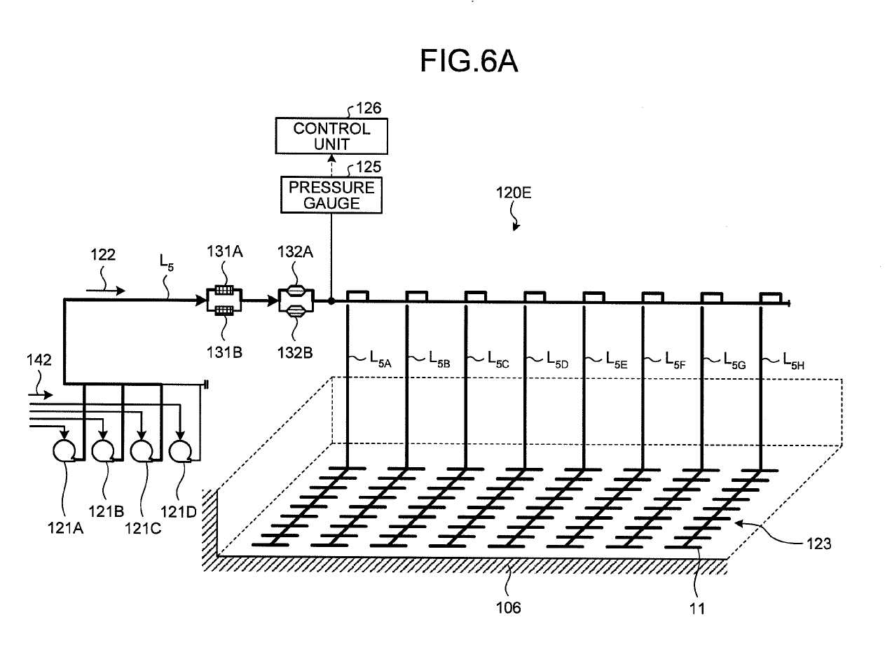

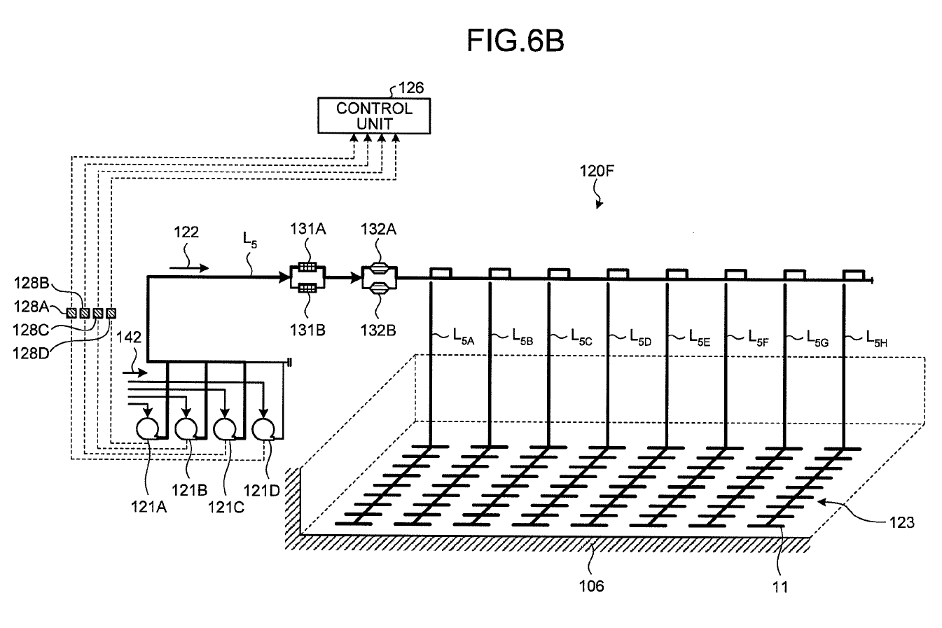

FIGS. 4A and 4B are schematic diagrams of the aeration apparatus according to the present embodiment. FIGS. 5A and 5B and FIGS. 6A and 6B are schematic diagrams of another aeration apparatus according to the present embodiment.

As shown in FIG. 4A, an aeration apparatus 120A according to the present embodiment is immersed in diluted used seawater (not shown), which is water to be treated, and generates fine air bubbles in the diluted used seawater. This aeration apparatus includes: the air supply line L₅ that supplies the air 122 from blowers 121A to 121D (in the present embodiment, four blowers) serving as discharge units; a pressure gauge 125 installed in the air supply line L₅; and aeration nozzles 123 each including the diffuser membrane 11 having slits for supplying the air. When air supply pressure exceeds a predetermined threshold value based on a result of measurement by the pressure gauge 125, fresh water or water vapor is temporarily supplied to an air supply pipe.

Two cooling units 131A and 131B and two filters 132A and 132B are provided in the air supply line L₅. The air compressed by the blowers 121A to 121D is thereby cooled and then filtrated. Normally, two or three of the four blowers are used for operation, and one or two of them are reserve blowers. Since the aeration apparatus must be continuously operated, only one of the two cooling units 131A and 131B and only one of the two filters 132A and 132B are normally used, and the others are used for maintenance.

In general, the salt concentration in seawater is 3.4%, and 3.4% of salts are dissolved in 96.6% of water. The salt includes 77.9% of sodium chloride, 9.6% of magnesium chloride, 6.1% of magnesium sulfate, 4.0% of calcium sulfate, 2.1% of potassium chloride, and 0.2% of other salts.

Of these salts, calcium sulfate is deposited first as seawater is concentrated (dried), and the precipitation threshold value of the salt concentration in seawater is about 14%.

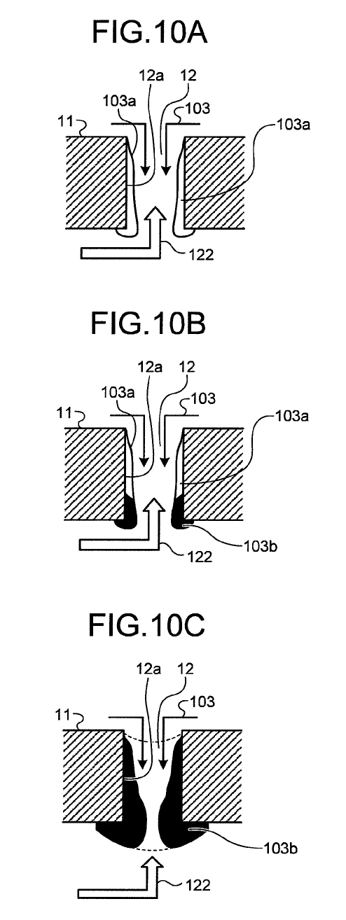

A mechanism in which precipitates are deposited in the slits 12 is explained with reference to FIGS. 10A to 10C.

FIG. 10A depicts the outflow of air (humid air having a low degree of saturation), the inflow of seawater, and a state of concentrated seawater in the slit of the diffuser membrane. FIG. 10B depicts the outflow of air, the inflow of seawater, and a state of concentrated seawater in the slit of the diffuser membrane. FIG. 10C depicts the outflow of air, the inflow of seawater, and states of concentrated seawater and precipitates in the slit of the diffuser membrane.

In the present invention, the slits 12 are cuts formed in the diffuser membrane 11, and the gap of each slit 12 serves as a discharge passage of air.

The seawater 103 is in contact with slit wall surfaces 12a that form the passage. The introduction of the air 122 causes the seawater 103 to be dried and concentrated to form concentrated seawater 103a. A precipitate 103b is then deposited on the slit wall surfaces and clogs the passage in the slits 12.

FIG. 10A depicts a state in which salt content in seawater is gradually concentrated as the seawater is dried to form the concentrated seawater 103a due to low relative humidity of the air 122. However, even if the concentration of the seawater is initiated, the deposition of calcium sulfate and the like does not occur when the salt concentration in the seawater is about 14% or less.

In the state shown in FIG. 10B, the precipitate 103b is generated in portions of the concentrated seawater 103a in which the salt concentration in the seawater locally exceeds approximately 14%. In this state, the amount of the precipitate 103b is very small. Therefore, although the pressure loss when the air 122 passes through the slits 12 increases slightly, the air 122 can pass through the slits 12.

On the other hand, in the state shown in FIG. 10C, because the concentration of the concentrated seawater 103a has proceeded further, a clogged (plugged) state due to the precipitate 103b is formed, and the pressure loss becomes high. Even in this state, the passage of the air 122 remains; however, a discharge unit is under a great burden.

Therefore, after such a state is generated, an increase in pressure loss is measured by the pressure gauge as described below, to cause air fluctuation so as to remove the precipitate.

In the present embodiment, to quickly remove the precipitates 103b and return to a normal state when the precipitates 103b are generated in the slits 12, supply pressure of the air 122 is monitored by the pressure gauge 125. When a predetermined threshold value is exceeded based on a result of measurement by the pressure gauge 125, the control unit 126 issues a command to operate a pump P₁ to supply fresh water 141 temporarily. Further, the control unit 126 may not be used as in the present embodiment, and an operator can perform manual control according to a change in pressure fluctuation.

That is, when the supply pressure of air exceeds a predetermined threshold value based on a result of the measurement by the pressure gauge 125, the control unit 126 introduces the fresh water 141 from a fresh water tank 140 to branch lines L_{5A} to L_{5H} branched from the air supply line L₅.

Accordingly, moisture accompanied with air reaches the precipitate 103b adhered to the slit 12, and the precipitate is dissolved and removed due to a deliquescent effect of the precipitate and the moisture. As the number of slits increases, from which the precipitate is removed, supplied air can pass through easily, and the diffuser membrane 11 rapidly shrinks. With this shrinkage, the precipitate 103b adhered to the slit 12 is crushed and discharged to the outside of the diffuser membrane 11 due to the supplied air.

This is because pressure loss in an individual diffuser membrane of a number of diffuser membranes can be indirectly ascertained by measuring the supply air pressure by the pressure gauge, thereby enabling to determine an increase in pressure loss with respect to the diffuser membrane in the present embodiment.

The presence of an increase in pressure loss can be individually determined by measuring a pressure difference between the inside and outside of the diffuser membrane.

FIG. 3B is a schematic diagram of the inner structure of an expanded state of the aeration nozzle.

When a matter adheres to the slit 12 of the diffuser membrane 11, the pressure loss of the diffuser membrane increases to expand the diffuser membrane 11. As shown in FIG. 3B, when an adhered matter is formed in the slit, the pressure loss increases to promote the expansion of the diffuser membrane 11, and the diameter thereof increases from a diameter D₀ in the expanded state in a normal diffused air state to D₁ in a further expanded state.

In the further expanded state, if the fresh water 141 is supplied to air, the precipitates are removed due to the deliquescent effect. As the number of slits increases, from which the precipitate is removed, supplied air can pass through easily, and rubber of the diffuser membrane 11 rapidly shrinks. That is, the diameter of the diffuser membrane 11 is changed from the state of D₁ to the state of D₂.

Due to the shrinkage, the matter adhered to the slit 12 falls down. Even in this state, because discharge of air is continued from the slit 12, the fallen adhered matter is discharged to the outside of the diffuser membrane 11.

In the present embodiment, an increase in pressure loss caused by the precipitate adhered to the slit of the diffuser membrane 11 is then ascertained by the pressure gauge 125. However, the present invention is not limited thereto, and an ammeter can be used to measure a current value of the blower, thereby indirectly ascertaining an increase in pressure loss.

This is because the blowers 121A to 121D are set to constantly supply a predetermined amount of air to the diffuser membrane 11, when an amount of supplied air decreases due to the precipitate adhered to the slit, the current value increases in order to drive the blowers 121A to 121D.

Therefore, ammeters 128A to 128D that measure the current values of respective blowers 121A to 121D are provided, as in the aeration apparatus 120B according to the present embodiment shown in FIG. 4B. The presence of an increase in the current value of the blower currently being operated is then confirmed by the ammeters 128A to 128D, respectively, and when there is an increase in the current value, it is determined that there is an increase in pressure loss, and it suffices that the blowers are operated as described above.

An air discharge unit (a blower) includes a positive displacement type that supplies a certain capacity and a non-positive displacement type. An amount of air of an air supply system or the number of revolutions of the air discharge unit can be adopted as an index for ascertaining an increase in pressure loss of the diffuser membrane, other than using the pressure gauge or the ammeter described above. When the amount of air is used as the index for ascertaining an increase in pressure loss of the diffuser membrane, if the pressure loss of the diffuser membrane increases, the amount of air decreases. Therefore, an air flow rate of the supplied air is measured to confirm a decrease in the air flow rate, and when the air flow rate decreases, it is determined that there is an increase in pressure loss, and it suffices that operations of the blowers as described above are performed.

Further, a decrease in the air flow rate can be also ascertained by the number of revolutions of the blower.

As the air discharge unit, for example, a unit that supplies air to the diffuser membrane such as an air blower or compressor can be used other than the blower.

In the present embodiment, the determination as to whether there is an increase in pressure loss with respect to the diffuser membrane is performed by, for example, at least one of a unit that measures pressure of supplied air or the amount of air, and a unit that measures the current value or the number of revolutions of the discharge unit; however, the present invention is not limited thereto.

At the time of introducing the fresh water 141 into the branch lines L_{5A} to L_{5H} branched from the air supply line L₅, a nozzle 127 can be used so that misted water is accompanied with the air 122, as in an aeration apparatus 120C shown in FIG. 5A.

Further, an aeration apparatus 120D shown in FIG. 5B includes the ammeters 128A to 128D, instead of using the pressure gauge 125. The presence of an increase in the current value of the blower currently being operated is confirmed by the ammeters 128A to 128D, and when there is an increase in the current value, it is determined that there is an increase in pressure loss, and it suffices that an operation to supply water as described above is performed.

In FIGS. 4A and 4B and FIGS. 5A, and 5B, the fresh water 141 is supplied from the fresh water tank 140; however, the present invention is not limited to the supply of the fresh water 141, and for example, water vapor can be also supplied.

Furthermore, an aeration apparatus 120E shown in FIG. 6A includes an inlet spray nozzle (not shown) that supplies moisture 142 to the vicinity of air inlet ports of the blowers 121A to 121D serving as the discharge units. While the fresh water tank 140 is installed in FIG. 5A, only the inlet spray nozzle can be provided with respect to the blowers 121A to 121D.

In this case, the control unit 126 adds the moisture 142 to the inlet side of the respective blowers 121A to 121D via a moisture supply unit (not shown) (moisture is evaporated before entering into the blower body), and regulates a cooling amount by a cooler 131A on the outlet side of the blowers, so that air passing through the slits 12 of the aeration nozzle becomes saturated moist air.

That is, the temperature of the air 122 pressurized and compressed by the blowers 121A to 121D becomes as high as 100° C. At this time, the air 122 to be supplied becomes moisture rich by supplying the extra moisture 142. Thereafter, when the temperature of the air is decreased (for example, to 40° C.) by the cooler 131, because there is no change in the amount of the moisture in the air 122, the degree of saturation (relative humidity) of the moisture of the cooled air 122 increases. As a result, the relative humidity of the air in the slit 12 of the aeration nozzle 123 becomes 100%. If an amount of water to be added to intake air is further increased, the air becomes saturated moist air including water mist and becomes an air-moisture two-phase state.

Accordingly, the deliquescent effect can be promoted with respect to the precipitates.

Even if the relative humidity of the atmosphere sucked by the blowers is 100% on the inlet side of the blowers 121A to 121D, the relative humidity of the air in the slit 12 of the aeration nozzle 123 may not be 100% as a result of compressing and cooling. In this case, when the deficient moisture 142 is replenished at the inlets of the blowers, moisture does not evaporate and enter into the blowers, and this is not preferable. In this case, the moisture 142 such as fresh water can be supplied on the outlet side of the blowers 121A to 121D or on a downstream side of the coolers 131A and 131B.

When the precipitates are removed and air becomes a normal diffused air state (supply pressure of the air becomes lower than a predetermined threshold value based on a result of measurement by the pressure gauge 125), the fresh water 141 or water vapor can be further supplied to prevent clogging of the slit that generates fine air bubbles.

That is, when the supply pressure of air is normal, moisture is accompanied with the air 122 supplied to the slit 12 so that seawater 103 is not dried and concentrated.

More preferably, the air 122 to be supplied can be moist air with a high water content (with high relative humidity) and further, can be in a state that the relative humidity of the air 122 is high (preferably, the air becomes saturated moist air with the relative humidity of 100%, or saturated moist air including water mist), thereby suppressing generation of precipitates.

Another aeration apparatus 120F shown in FIG. 6B includes the ammeters 128A to 128D, instead of using the pressure gauge 125. The presence of an increase in the current value of the blower currently being operated is confirmed by the ammeters 128A to 128D, and when there is an increase in the current value, it is determined that there is an increase in pressure loss, and it suffices that the operation of supplying the moisture 142 as described above is performed.

The aeration nozzle according to the present embodiment is explained next. The present invention provides an aeration nozzle that can cause precipitates deposited on the diffuser membrane 11 to fall easily.

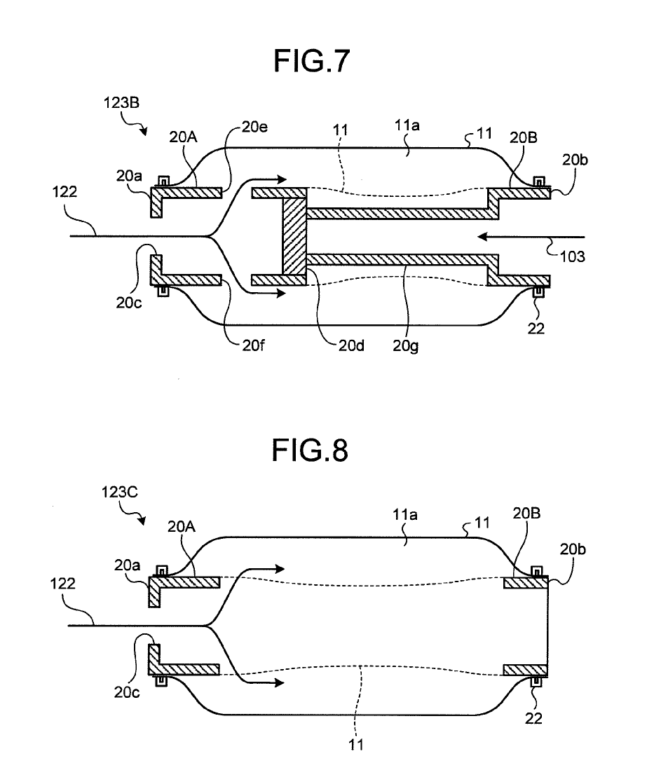

FIG. 7 is a schematic diagram of the inner structure of another aeration nozzle according to the present embodiment.

As shown in FIG. 7, another aeration nozzle 123B according to the present embodiment includes a cylindrical base-side support body 20A, into which air is introduced, a hollow cylindrical body 20g having a diameter smaller than that of the base-side support body 20A and provided axially via a partition board 20d, an end support body 20B provided at the other end of the hollow cylindrical body 20g and having a substantially same diameter as that of the base-side support body 20A, a tube-type diffuser membrane 11 fastened with the fastening members 22 at the opposite ends, while covering the base-side support body 20A and the end support body 20B, a number of slits (not shown) provided in the diffuser membrane 11, and air outlets 20e and 20f provided on the side of the base-side support body 20A to cause the air 122 to introduce into a pressurized space 11a between an inner circumference of the diffuser membrane 11 and an outer circumference of the support body to flow out in front of the partition board 20d. Therefore, the air 122 flowing into the aeration nozzle 123B from the header flows into the base-side support body 20A from an air inlet port 20c, and then flows out to the pressurized space 11a from the air outlets 20e and 20f on the side, as shown by an arrow in FIG. 7.

Subsequently, deliquescence of the precipitate is started by the moisture accompanied with the air 122, and when deliquescence is continuously generated and air can pass through the slit easily, as shown by the broken line in FIG. 7, the diffuser membrane 11 shrinks. As a result, a portion of the hollow cylindrical body 20g having a smaller diameter deforms to deform the slits 12 in the diffuser membrane 11, thereby promoting fall of the precipitate.

FIG. 8 is a schematic diagram of the inner structure of another aeration nozzle according to the present embodiment. An aeration nozzle 123C according to the present embodiment includes the cylindrical base-side support body 20A, into which air is introduced, the end support body 20B having a substantially same diameter as that of the base-side support body 20A, the tube-type diffuser membrane 11 fastened with the fastening members 22, while covering the base-side support body 20A and the end support body 20B, and a number of slits provided in the diffuser membrane 11.

The aeration nozzle 123A as shown in FIG. 3A has a configuration such that the diffuser membrane 11 covers the circumference of the support body 20. On the other hand, in the aeration nozzle 123C shown in FIG. 8, the diffuser membrane 11 is self-sustaining, and only the end side thereof is supported by the end support body 20B. Therefore, at the time of supplying the air 122, the diffuser membrane 11 is expanded. However, when the supply of the air 122 is suspended, the diffuser membrane 11 shrinks and deforms as shown by the broken line, thereby facilitating fall of the precipitate adhered to the slit.

Disk-type and plate-type aeration nozzles are explained with respect to the tube-type aeration nozzle.

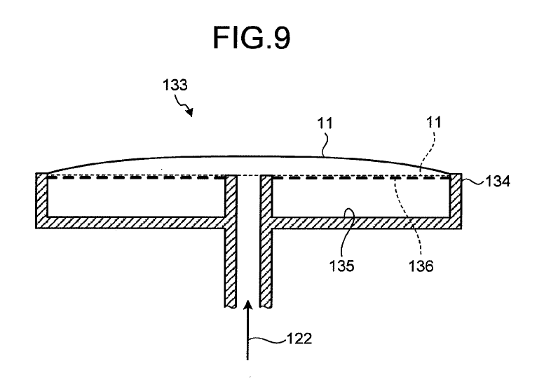

FIG. 9 is a schematic diagram of a disk-type aeration nozzle according to the present embodiment. As shown in FIG. 9, a disk-type aeration nozzle 133 includes, for example, a receiving unit 135 for precipitates at the bottom of the cylindrical support body 134 of the rubber-made diffuser membrane 11. A partition such as a punching metal 136 is provided in the receiving unit 135, so that introduction flow of the air 122 is not blocked.

Therefore, the diffuser membrane 11 is expanded at the time of supplying the air 122. However, when the supply of the air 122 is suspended, the diffuser membrane 11 shrinks and deforms as shown by the broken line, thereby facilitating fall of the precipitate adhered to the slit.

Therefore, the diffuser membrane 11 expands at the time of supplying the air 122. However, when deliquescence of the precipitate is started by the moisture accompanied with the air 122 and deliquescence is continuously generated and air can pass through the slit easily, as shown by the broken line, the diffuser membrane 11 shrinks and deforms, thereby promoting fall of the precipitate.

In the present embodiment, while seawater has been exemplified as the water to be treated, the present invention is not limited thereto. For example, plugging caused by deposition of contamination components such as sludge on diffuser slits (membrane slits) can be prevented in the aeration apparatus for aeration of contaminated water in decontamination processing, and thus the aeration apparatus can be stably operated for a long time.

### REFERENCE SIGNS LIST

11 diffuser membrane

12 slit

100 seawater flue gas desulphurization apparatus

102 flue gas desulphurization absorber

103 seawater

103A used seawater

103B diluted used seawater

105 dilution-mixing basin

106 oxidation basin

120, 120A to 120F aeration apparatus

123, 123A to 123C, 133 aeration nozzle

125 pressure gauge

126 control unit

140 fresh water tank

141 fresh water

142 moisture

1. An aeration apparatus that is immersed in water to be treated and generates fine air bubbles in the water to be treated, the aeration apparatus comprising:
an air supply pipe for supplying air through a discharge unit;
a pressure gauge installed in the air supply pipe; and
an aeration nozzle including a diffuser membrane having a slit, the air being supplied through the slit to the aeration nozzle, wherein
when there is an increase in pressure loss with respect to the diffuser membrane, fresh water or water vapor is temporarily supplied to the air supply pipe.

2. The aeration apparatus according to claim 1, wherein determination as to whether there is an increase in pressure loss with respect to the diffuser membrane is performed by at least one of a unit that measures pressure of supplied air or an amount of air, and a unit that measures a current value or number of revolutions of the discharge unit.

3. The aeration apparatus according to claim 1, wherein
the aeration nozzle includes:
a diffuser membrane that covers a support body into which air is introduced; and
a number of slits provided in the diffuser membrane, and
fine air bubbles are caused to flow out from the slits.

4. The aeration apparatus according to claim 1, wherein
the aeration nozzle includes:
a cylindrical base-side support body into which air is introduced;
a hollow cylindrical body having a diameter smaller than that of the base-side support body and provided axially via a partition board;
an end support body provided at the other end of the hollow cylindrical body and having a substantially same diameter as that of the base-side support body;
a tube-type diffuser membrane that is fastened at opposite ends, while covering the base-side support body and the end support body;
a plurality of slits provided in the diffuser membrane; and
an air outlet that is provided on a side of the base-side support body and causes air to introduce into a pressurized space between an inner circumference of a diffuser membrane and an outer circumference of a support body to flow out in front of the partition board.

5. The aeration apparatus according to claim 1, wherein
the aeration nozzle includes:
a cylindrical base-side support body into which air is introduced;
an end support body having a substantially same diameter as that of the base-side support body;
a tube-type diffuser membrane that is fastened while covering the base-side support body and the end support body; and
a plurality of slits provided in the diffuser membrane.

6. A seawater flue gas desulphurization apparatus comprising:
a desulfurizer that uses seawater as an absorbent;
a water passage for allowing used seawater discharged from the desulfurizer to flow therethrough and be discharged; and
the aeration apparatus according to claim 1 that is disposed in the water passage, the aeration apparatus generating fine air bubbles in the used seawater to decarbonate the used seawater.

7. An operation method of an aeration apparatus, the method comprising:
using an aeration apparatus that is immersed in water to be treated and generates fine air bubbles in the water to be treated from a slit; and
temporarily supplying fresh water or water vapor when there is an increase in pressure loss with respect to the diffuser membrane, to remove a precipitate in the slit, at a time of supplying air through a discharge unit.

8. The operation method of an aeration apparatus according to claim 7, wherein when pressure loss is resolved, fresh water or water vapor is further supplied to prevent clogging of a slit that generates fine air bubbles.
